(19) United States
(12) Patent Application Publication
(10) Pub. No.: US 2009/0149455 A1
(43) Pub. Date: Jun. 11, 2009

(54) Use of Triazolopyrimidines for Controlling Plant Diseases on Legumes

(75) Inventors: Olaf Gebauer, Leverkusen (DE); Hans-Ludwig Elbe, Wuppertal (DE); Jorg Nico Greul, Leichlingen (DE); Oliver Guth, Leverkusen (DE); Herbert Gayer, Monheim (DE); Ulrich Heinemann, Leichlingen (DE); Stefan Herrmann, Langenfeld (DE); Peter Dahmen, Nuess (DE); Ulrike Wachendorff-Neumann, Neuwied (DE); Ingo Wetcholowsky, Langenfeld (DE); Hiroyuki Hadano, Tochigi (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 11/916,961

(22) PCT Filed: May 26, 2006
(86) PCT No.: PCT/EP2006/005073

§ 371 Date: Jun. 11, 2008

(30) Foreign Application Priority Data
Jun. 8, 2005 (DE) 102005026577.4

(51) Int. Cl. A01N 43/90; A01P 3/00

(52) U.S. Cl. 514/233.2; 514/259.31; 514/252.02

(57) ABSTRACT

The triazolopyrimidines of the general formula (I)

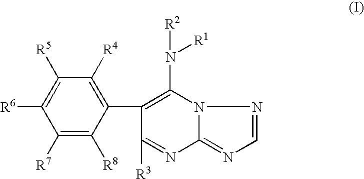

in which
R², R², R³, R⁴, R⁵, R⁶, R⁷ and R⁸ are as defined in the description are highly suitable for use against rust diseases on leguminous plants.

The present invention relates to the use of triazolopyrimidines for controlling phytopathogenic fungi, in particular rust species on leguminous plants.

It is already known that certain triazolopyrimidines have fungicidal properties: see, for example, WO 2002/38565.

However, since the ecological and economical demands made on modem fungicides are increasing constantly, for example with respect to activity spectrum, toxicity, selectivity, application rate, formation of residues and favourable manufacture, and there can furthermore be problems, for example, with resistance, there is constant need to develop novel fungicides which, at least in some areas, have advantages over those of the prior art. In particular the increased occurrence of rust diseases in soya beans caused by Phakopsora pachyrhizi and Phakopsora meibomiae require fungicides controlling these diseases effectively.

Many known fungicides are unsuitable for controlling rust diseases in soya beans. It has now been found that triazolopyrimidines of the formula (I) have very good fungicidal properties against diseases of soya beans, in particular against rust diseases on soya beans, such as Phakopsora pachyrhizi and Phakopsora meibomiae.

The invention also provides the use of triazolopyrimidines of the formula (I) for controlling diseases on leguminous plants, in particular rust diseases on soya beans.

The formula (I) provides a general definition of the compounds of group (1).

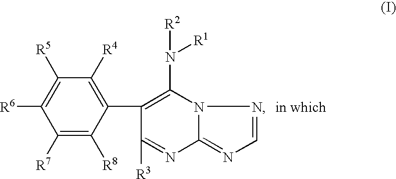

R¹ represents C₁-C₆-alkyl, C₁-C₆-haloalkyl or C₂-C₆-alkenyl,

R² represents hydrogen or C₁-C₆-alkyl, or

R¹ and R² together with the nitrogen atom to which they are attached form a five- or six-membered heterocycle which may additionally contain up to three heteroatoms selected from the group consisting of nitrogen, oxygen and sulphur and which may be substituted by up to 3 groups selected from the group consisting of trifluoromethyl and methyl, where two oxygen atoms must not be adjacent,

R³ represents C₁-C₄-alkyl, C₁-C₄-alkoxy, C₁-C₄-haloalkyl, cyano, bromine or chlorine, and

R⁴ to R⁸ independently of one another represent hydrogen, fluorine, chlorine, methyl or trifluoromethyl.

Preference is given to triazolopyrimidines of the formula (I) in which

R¹ represents C₁-C₆-alkyl or C₁-C₆-haloalkyl,

R² represents hydrogen or C₁-C₆-alkyl, or

R¹ and R² together with the nitrogen atom to which they are attached form a five- or six-membered heterocycle which may additionally contain up to three heteroatoms selected from the group consisting of nitrogen, oxygen and sulphur and which may be substituted by up to 3 groups selected from the group consisting of trifluoromethyl and methyl, where two oxygen atoms must not be adjacent,

R³ represents methyl, cyano or chlorine, and

R⁴ to R⁸ independently of one another represent hydrogen, fluorine, chlorine, methyl or trifluoromethyl.

Particular preference is given to triazolopyrimidines of the formula (I) in which

R¹ represents 3-methylbut-2-yl, 3,3,-dimethylbut-2-yl, 2,2,2-trifluoroethyl or 1,1,1-trifluoro-prop-2-yl,

R² represents hydrogen, or

R¹and R² together represent —(CH₂)—CH(CH₃)—(CH₂)₂—,

R³ represents methyl or chlorine,

R⁴ represents methyl, chlorine or fluorine and

R⁵ to R⁸ represent hydrogen;

particular preference is furthermore given to triazolopyrimidines of the formula (I) in which

R¹ represents 3-methylbut-2-yl, 3,3,-dimethylbut-2-yl, 2,2,2-trifluoroethyl or 1,1,1-trifluoro-prop-2-yl,

R² represents hydrogen, or

R¹ and R² together represent —(CH₂)—CH(CH₃)—(CH₂)₂—,

R³ represents methyl or chlorine, and

R⁴ and R⁶ independently of one another represent methyl, chlorine or fluorine and R⁵, R⁷ and R⁸ represents hydrogen;

particular preference is furthermore given to triazolopyrimidines of the formula (I) in which

R¹ represents 3-methylbut-2-yl, 3,3,-dimethylbut-2-yl, 2,2,2-trifluoroethyl or 1,1,1-trifluoro-prop-2-yl,

R² represents hydrogen, or

R¹ and R² together represent —(CH₂)—CH(CH₃)—(CH₂)₂—,

R³ represents methyl or chlorine, and

R⁴ and R⁸ independently of one another represent methyl, chlorine or fluorine and R⁵, R⁶ and R⁷ represent hydrogen;

particular preference is furthermore given to triazolopyrimidines of the formula (I) in which

R¹ represents 3-methylbut-2-yl, 3,3,-dimethylbut-2-yl, 2,2,2-trifluoroethyl or 1,1,1-trifluoro-prop-2-yl,

R² represents hydrogen, or

R¹ and R² together represent —(CH₂)—CH(CH₃)—(CH₂)₂—,

R³ represents methyl or chlorine, and

R⁴, R⁶ and R⁸ independently of one another represent methyl, chlorine or fluorine and R⁵ and R⁷ represent hydrogen.

Very particular preference is given to triazolopyrimidines of the formula (I) in which

R¹ represents 3-methylbut-2-yl, 3,3,-dimethylbut-2-yl, 2,2,2-trifluoroethyl or 1,1,1-trifluoro-prop-2-yl,

R² represents hydrogen, or

R¹ and R² together represent —(CH₂)—CH(CH₃)—(CH₂)₂—,

R³ represents chlorine,

R⁴, R⁶ and R⁸ represent fluorine, and

R⁵ and R⁷ represent hydrogen.

The formula (I) encompasses in particular the following preferred triazolopyrimidines:

(1- 1) 5-Chloro-N-[(1R)-1,2-dimethylpropyl]-6-(2,4,6-trifluorophenyl)[1,2,4]triazolo[1,5-a]-pyrimidine-7-amine (known from WO2002/38565)

(1-2) 5-Chloro-6-(2,4,6-trifluorophenyl)-N-(1R)-(1,2,2-trimethylpropyl)[1,2,4]triazolo[1,5-a]-pyrimidine-7-amine (known from WO2002/38565)

(1-3) 5-Chloro-7-(4-methylpiperidin-1-yl)-6-(2,4,6-trifluorophenyl)[1,2,4]triazolo[1,5-a]-pyrimidine

(1-4) 5-Chloro-6-(2,4,6-trifluorophenyl)-N-(1S)-(1,1,1-trifluoropropan-2-yl)[1,2,4]triazolo-[1,5-a]pyrimidine-7-amine (known from WO98/46608)

(1-5) 5-Chloro-6-(2,4,6-trifluorophenyl)-N-(2,2,2-trifluoroethyl)[1,2,4]triazolo[1,5-a]pyrimidine-7-amine (known from WO98/46608)

The compounds of the formula (I) can be present both in pure form and as mixtures of different possible isomeric forms, in particular of stereoisomers, such as E and Z, threo and erythro, and also optical isomers, such as R and S isomers or atropisomers, and, if appropriate, also of tautomers. The invention encompasses both the pure isomers and their mixtures.

Moreover, the active compounds according to the invention have very good fungicidal properties and, in addition to the control of rust diseases, can also be used for controlling further phytopathogenic fungi, such as Plasmodiophoromycetes, Oomycetes, Chytridiomycetes, Zygomycetes, Ascomycetes, Basidiomycetes, Deuteromycetes etc.

Some pathogens causing fungal and bacterial diseases which come under the generic names listed above may be mentioned as examples, but not by way of limitation:

diseases caused by powdery mildew pathogens, such as, for example Blumeria species such as, for example, Blumeria graminis; Podosphaera species such as, for example, Podosphaera leucotricha; Sphaerotheca species such as, for example, Sphaerotheca fuliginea; Uncinula species such as, for example, Uncinula necator;

diseases caused by rust pathogens such as, for example, Gymnosporangium species such as, for example, Gymnosporangium sabinae Hemileia species such as, for example, Hemileia vastatrix; Phakopsora species such as, for example, Phakopsora pachyrhizi and Phakopsora meibomiae; Puccinia species such as, for example, Puccinia recondita; Uromyces species such as, for example, Uromyces appendiculatus;

diseases caused by pathogens from the Oomycetes group such as, for example, Bremia species such as, for example, Bremia lactucae; Peronospora species such as, for example, Peronospora pisi or P. brassicae; Phytophthora species such as, for example, Phytophthora infestans; Plasmopara species such as, for example, Plasmopara viticola; Pseudoperonospora species such as, for example, Pseudoperonospora humuli or Pseudoperonospora cubensis; Pythium species such as, for example, Pythium ultimum;

leaf spot diseases and leaf wilts caused by, for example, Alternaria species such as, for example, Altemaria solani; Cercospora species such as, for example, Cercospora beticola; Cladiosporum species such as, for example, Cladiosporium cucumerinum; Cochliobolus species such as, for example, Cochliobolus sativus (conidial form: Drechslera, syn: Helminthosporium); Colletotrichum species such as, for example, Colletotrichum lindemuthanium; Cycloconium species such as, for example, Cycloconium oleaginum; Diaporthe species such as, for example, Diaporthe citri; Elsinoe species such as, for example, Elsinoe fawcettii; Gloeosporium species such as, for example, Gloeosporium laeticolor; Glomerella species such as, for example, Glomerella cingulata; Guignardia species such as, for example, Guignardia bidwelli; Leptosphaeria species such as, for example, Leptosphaeria maculans; Magnaporthe species such as, for example, Magnaporthe grisea; Mycosphaerella species such as, for example, Mycosphaerelle graminicola; Phaeosphaeria species such as, for example, Phaeosphaeria nodorum; Pyrenophora species such as, for example, Pyrenophora teres; Ramularia species such as, for example, Ramularia collo-cygni; Rhynchosporium species such as, for example, Rhynchosporium secalis; Septoria species such as, for example, Septoria apii; Typhula species such as, for example, Typhula incamata; Venturia species such as, for example, Venturia inaequalis;

root and stem diseases caused by, for example, Corticium species such as, for example, Corticium graminearum; Fusarium species such as, for example, Fusarium oxysporum; Gaeumannomyces species such as, for example, Gaeumannomyces graminis; Rhizoctonia species such as, for example, Rhizoctonia solani; Tapesia species such as, for example, Tapesia acuformis; Thielaviopsis species such as, for example, Thielaviopsis basicola;

ear and panicle diseases (including maize cobs), caused by, for example, Alternaria species such as, for example, Altemaria spp.; Aspergillus species such as, for example, Aspergillus flavus; Cladosporium species such as, for example, Cladosporium spp.; Claviceps species such as, for example, Claviceps purpurea; Fusarium species such as, for example, Fusarium culmorum; Gibberella species such as, for example, Gibberella zeae; Monographella species such as, for example, Monographella nivalis;

diseases caused by smuts such as, for example, Sphacelotheca species such as, for example, Sphacelotheca reiliana; Tilletia species such as, for example, Tilletia caries; Urocystis species such as, for example, Urocystis occulta; Ustilago species such as, for example, Ustilago nuda;

fruit rots caused by, for example, Aspergillus species such as, for example, Aspergillus flavus; Botrytis species such as, for example, Botrytis cinerea; Penicillium species such as, for example, Penicillium expansum; Sclerotinia species such as, for example, Sclerotinia sclerotiorum; Verticilium species such as, for example, Verticilium alboatrum;

seed- and soil-bome rot and wilts, and seedling diseases, caused by, for example, Fusarium species such as, for example, Fusarium culmorum; Phytophthora species such as, for example, Phytophthora cactorum; Pythium species such as, for example, Pythium ultimum; Rhizoctonia species such as, for example, Rhizoctonia solani; Sclerotium species such as, for example, Sclerotium rolfsii;

cancers, galls and witches' broom disease, caused by, for example, Nectria species such as, for example, Nectria galligena;

wilts caused by, for example, Monilinia species such as, for example, Monilinia laxa;

deformations of leaves, flowers and fruits, caused by, for example, Taphrina species such as, for example, Taphrina deformans;

degenerative diseases of woody species, caused by, for example, Esca species such as, for example, Phaemoniella clamydospora;

diseases of inflorescences and seeds, caused by, for example, Botrytis species such as, for example, Botrytis cinerea;

diseases of the plant tubers, caused by, for example, Rhizoctonia species such as, for example, Rhizoctonia solani;

diseases caused by bacterial pathogens such as, for example, Xanthomonas species, such as, for example, Xanthomonas campestris pv. oryzae; Pseudomonas species, such as, for example, Pseudomonas syringae pv. lachrymans, Erwinia species, such as, for example, Erwinia amylovora;

The triazolopyrimidines according to the invention are preferably suitable for use against diseases on leguminous plants, in particular soya bean rust.

The term leguminous plants includes peas, beans, lentils, peanuts, lupins and in particular soya beans.

The triazolopyrimidines according to the invention are suitable in particular for use in the cultivation of soya beans.

The triazolopyrimidines according to the invention are very particularly suitable for use against rust diseases on soya beans, in particular Phakopsora pachyrhizi or Phakopsora meibomiae.

The invention also provides a method for controlling diseases on leguminous plants, in particular rust diseases in soya beans, which comprises applying a triazolopyrimidine of the formula (I) to the leguminous plant, its surroundings or its seed.

The fact that the active compounds are well tolerated by plants at the concentrations required for controlling plant diseases permits a treatment of entire plants (above-ground parts of plants and roots), of propagation stock and seed, and of the soil. The active compound combinations according to the invention can be used for foliar application or else as seed dressings.

The fact that the active compounds which can be used are well tolerated by plants at the concentrations required for controlling plant diseases permits a treatment of the seed. Accordingly, the active compounds according to the invention can be used as seed dressings.

A large part of the damage to crop plants which is caused by phytopathogenic fungi occurs as early as when the seed is attacked during storage and after the seed is introduced into the soil, as well as during and immediately after germination of the plants. This phase is particularly critical since the roots and shoots of the growing plant are particularly sensitive and even minor damage can lead to the death of the whole plant. Protecting the seed and the germinating plant by the use of suitable compositions is therefore of particularly great interest.

The control of phytopathogenic fungi which damage plants post-emergence is carried out primarily by treating the soil and the above-ground parts of plants with crop protection agents. Owing to the concerns regarding a possible impact of crop protection agents on the environment and the health of humans and animals, there are efforts to reduce the amount of active compounds applied.

The present invention therefore also relates to a method for the protection of seed and germinating plants from attack by phytopathogenic fungi, by treating the seed with a composition according to the invention.

The invention likewise relates to the use of the compositions according to the invention for the treatment of seed for protecting the seed and the germinating plant from phytopathogenic fungi.

Furthermore, the invention relates to seed which has been treated with a composition according to the invention so as to afford protection from phytopathogenic fungi.

One of the advantages of the present invention is that, by virtue of the particular systemic properties of the compositions according to the invention, treatment of the seed with these compositions not only protects the seed itself, but also the resulting plants after emergence, from phytopathogenic fungi. In this manner, the immediate treatment of the crop at the time of sowing or shortly thereafter can be dispensed with.

Furthermore, it must be considered as advantageous that the mixtures according to the invention can also be employed in particular in transgenic seed.

The compositions according to the invention are suitable for protecting seed of any plant variety which is employed in agriculture, in the greenhouse, in forests or in horticulture. In particular, this takes the form of seed of soya beans, beans and peanuts.

The composition according to the invention is applied to the seed either alone or in a suitable formulation. Preferably, the seed is treated in a state which is stable enough to avoid damage during treatment. In general, the seed may be treated at any point in time between harvest and sowing. The seed usually used has been separated from the plant and freed from cobs, shells, stalks, coats, hairs or the flesh of the fruits. Thus, for example, it is possible to use seed which has been harvested, cleaned and dried to a moisture content of below 15% by weight. Alternatively, it is also possible to use seed which, after drying, has, for example, been treated with water and then dried again.

When treating the seed, care must generally be taken that the amount of the composition according to the invention applied to the seed and/or the amount of further additives is/are chosen in such a way that the germination of the seed is not adversely affected, or that the resulting plant is not damaged. This must be borne in mind in particular in the case of active compounds which may have phytotoxic effects at certain application rates.

The compositions according to the invention can be applied directly, that is to say without comprising further components and without having been diluted. In general, it is preferable to apply the compositions to the seed in the form of a suitable formulation. Suitable formulations and methods for the treatment of seed are known to the skilled worker and are described, for example, in the following documents: U.S. Pat. No. 4,272,417 A, U.S. Pat, No. 4,245,432 A, U.S. Pat. No. 4,808,430 A, U.S. Pat. No. 5,876,739 A, US 2003/0176428 A1, WO 2002/080675 A1, WO 2002/028186 A2.

The active compound combinations according to the invention are also suitable for increasing the yield of crops. In addition, they show reduced toxicity and are well tolerated by plants.

According to the invention, it is possible to treat all plants and parts of plants. Plants are to be understood here as meaning all plants and plant populations, such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including plant cultivars which can or cannot be protected by plant breeders' certificates. Parts of plants are to be understood as meaning all above-ground and below-ground parts and organs of plants, such as shoot, leaf, flower and root, examples which may be mentioned being leaves, needles, stems, trunks, flowers, fruit-bodies, fruits and seeds and also roots, tubers and rhizomes. Parts of plants also include harvested material and vegetative and generative propagation material, for example seedlings, tubers, rhizomes, cuttings and seeds.

The treatment of the plants and parts of plants according to the invention with the active compounds is carried out directly or by action on their environment, habitat or storage area according to customary treatment methods, for example by dipping, spraying, evaporating, atomizing, broadcasting, brushing-on and, in the case of propagation material, in particular in the case of seeds, furthermore by one- or multilayer coating.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof, are treated. The term “parts” or “parts of plants” or “plant parts” has been explained above.

Particularly preferably, plants of the plant cultivars which are in each case commercially available or in use are treated according to the invention.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions which can be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferably to be treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are soya beans. Traits that are emphasized are in particular increased defence of the plants against insects, by toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are soya bean varieties which are sold under the trade names YIELD GARD® (for example soya beans). Examples of herbicide-tolerant plants which may be mentioned are soya bean varieties which are sold under the trade names Roundup Ready® (tolerance to glyphosate, for example soya bean) and IMI®. Herbicide-resistant plants (plants bred in a conventional manner for herbicide tolerance) which may be mentioned also include the varieties sold under the name Clearfield®. Of course, these statements also apply to plant cultivars which have these genetic traits or genetic traits still to be developed, and which will be developed and/or marketed in the future.

In addition, the triazolopyrimidines according to the invention may also comprise further fungicidally, bactericidally or insecticidally active co-components.

### Fungicides:

1. Nucleic acid synthesis inhibitors

benalaxyl, benalaxyl-M, bupirimate, chiralaxyl, clozylacon, dimethirimol, ethirimol, furalaxyl, hymexazol, metalaxyl-M, ofurace, oxadixyl, oxolinic acid

2. Mitosis and cell division inhibitors

benomyl, carbendazim, diethofencarb, fuberidazole, pencycuron, thiabendazole, thiophanate-methyl, zoxamide

3. Inhibitors of the respiratory chain

3.1 Complex I

diflumetorim

3.2 Complex II

boscalid, carboxin, fenfuram, flutolanil, furametpyr, mepronil, oxycarboxin, penthiopyrad, thifluzamide

3.3 Complex III

azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin

3.4 Decouplers

dinocap, fluazinam

3.5 ATP production inhibitors

fentin acetate, fentin chloride, fentin hydroxide, silthiofam

4. Amino acid and protein biosynthesis inhibitors

andoprim, blasticidin-S, cyprodinil, kasugamycin, kasugamycin hydrochloride hydrate, mepanipyrim, pyrimethanil

5. Signal transduction inhibitors

fenpiclonil, fludioxonil, quinoxyfen

6. Lipid and membrane synthesis inhibitors

chlozolinate, iprodione, procymidone, vinclozolin

pyrazophos, edifenphos, iprobenfos (IBP), isoprothiolane

tolclofos-methyl, biphenyl

iodocarb, propamocarb, propamocarb hydrochloride

7. Inhibitors of ergosterol biosynthesis

fenhexamid,

azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, uniconazole, voriconazole, imazalil, imazalil sulphate, oxpoconazole, fenarimol, flurprimidol, nuarimol, pyrifenox, triforine, pefurazoate, prochloraz, triflumizole, viniconazole,

aldimorph, dodemorph, dodemorph acetate, fenpropimorph, tridemorph, fenpropidin, spiroxamine,

naftifine, pyributicarb, terbinafine

8. Cell wall synthesis inhibitors

benthiavalicarb, bialaphos, dimethomorph, flumorph, iprovalicarb, polyoxins, polyoxorim, validamycin A

9. Melanin biosynthesis inhibitors

capropamid, diclocymet, fenoxanil, phthalide, pyroquilon, tricyclazole

10. Resistance inductors

acibenzolar-S-methyl, probenazole, tiadinil

11. Compounds with multisite activity

captafol, captan, chlorothalonil, copper salts, such as: copper hydroxide, copper naphthenate, copper oxychloride, copper sulphate, copper oxide, oxine copper and Bordeaux mixture, dichlofluanid, dithianon, dodine, dodine free base, ferbam, folpet, fluorofolpet, guazatine, guazatine acetate, iminoctadine, iminoctadine albesilate, iminoctadine triacetate, mancopper, mancozeb, maneb, metiram, metiram zinc, propineb, sulphur and sulphur preparations comprising calcium polysulphide, thiram, tolylfluanid, zineb, ziram

12. Unknown

amibromdol, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methylsulphate, diphenylamine, ethaboxam, ferimzone, flumetover, flusulfamide, fluopicolide, fluoroimide, fosetyl-aluminium, fosetyl-sodium, fosetyl-calcium, hexachlorobenzene, 8-hydroxyquinoline sulphate, irumamycin, methasulfocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, phosphonic acid, piperalin, propanosine-sodium, proquinazid, pyrrolnitrin, quintozene, tecloftalam, tecnazene, triazoxide, trichlamid, zarilamid and 2,3,5,6-tetrachloro-4-(methylsulphonyl)pyridine, N-(4-chloro-2-nitrophenyl)-N-ethyl-4-methylbenzenesulphonamide, 2-amino4-methyl-N-phenyl-5-thiazolecarboxamide, 2-chloro-N-(2,3-dihydro-1,1,3-trimethyl-1-inden-4-yl)-3-pyridinecarboxamide, 3-[5-(4-chlorophenyl)-2,3-dimethylisoxazolidin-3-yl]pyridine, cis-1-(4-chlorophenyl)-2-(1H-1,2,4-triazol-1-yl)cycloheptanol, 2,4-dihydro-5-methoxy-2-methyl4-[[[[ 1-[3-(trifluoromethyl)phenyl]ethylidene]amino]oxy]methyl]phenyl]-3H-1,2,3-triazol-3-one (185336-79-2), methyl 1-(2,3-dihydro-2,2-dimethyl-1H-inden-1-yl)-1H-midazole-5-carboxylate, 3,4,5-trichloro-2,6-pyridinedicarbonitrile, methyl 2-[[[cyclopropyl[(4-methoxyphenyl)imino]methyl]thio]methyl]-α-(methoxymethylene)benzacetate, 4-chloro-α-propynyloxy-N-[2-[3-methoxy4-(2-propyn-yloxy)phenyl]ethyl]benzacetamide, (2S)-N-[2-[4-[[3-(4-chlorophenyl)-2-propynyl]oxy]-3-methoxy-phenyl]ethyl]-3-methyl-2-[(methylsulphonyl)amino]butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-]1,2,2-trimethylpropyl][1,2,4]triazolo[1,5-a]pyrimidine-7-amine, 5-chloro-N-[(1R)-1,2-dimethyl-propyl]-6-(2,4,6-trifluorophenyl)[1,2,4]triazolo[1,5-a]pyrimidine-7-amine, N-[1-(5-bromo-3-chloro-pyridin-2-yl)ethyl]-2,4-dichloronicotinamide, N-(5-bromo-3-chloropyridin-2-yl)methyl-2,4-dichloro-nicotinamide, 2-butoxy-6-iodo-3-propylbenzopyranon4-one, N-{(Z)-[(cyclopropylmethoxy)-imino][6-(difluoromethoxy)-2,3-difluorophenyl]methyl}-2-benzacetamide, N-(3-ethyl-3,5,5-trimethylcyclohexyl)-3-formylamino-2-hydroxybenzamide, 2-[[[[1-[3-(1-fluoro-2-phenylethyl)-oxy]phenyl]ethylidene]amino]oxy]methyl]-α-(methoxyimino)-N-methyl-α-benzacetamide, N-{2-[3-chloro-5-(trifluoromethyl)pyridin-2-yl]ethyl)-2-(trifluoromethyl)benzamide, N-(3′,4′-dichloro-5-fluorobiphenyl-2-yl)-3-(difluoromethyl)-1-methyl-1H-pyrazole4-carboxamide, N-(6-methoxy-3-pyridinyl)cyclopropanecarboxamide, 1-[(4-methoxyphenoxy)methyl]-2,2-dimethylpropyl-1H- imidazole-1-carboxylic acid, O-[1-[(4-methoxyphenoxy)methyl]-2,2-dimethylpropyl]-1H-imidazole-1-carbothioic acid, 2-(2-{[6-(3-chloro-2-methylphenoxy)-5-fluoropyrimidin4-yl]oxy}phenyl)-2-(methoxyimino)-N-methylacetamide

### Bactericides:

bronopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

### Insecticides/Acaricides/Nematicides:

1. Acetylcholinesterase (AChE) inhibitors

1.1 carbamates (for example alanycarb, aldicarb, aldoxycarb, allyxycarb, aminocarb, azamethiphos, bendiocarb, benfuracarb, bufencarb, butacarb, butocarboxim, butoxycarboxim, carbaryl, carbofuran, carbosulfan, chloethocarb, coumaphos, cyanofenphos, cyanophos, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, triazamate, trimethacarb, XMC, xylylcarb)

1.2 organophosphates (for example acephate, azamethiphos, azinphos (-methyl, -ethyl), bromophos-ethyl, bromfenvinfos (-methyl), butathiofos, cadusafos, carbophenothion, chlorethoxyfos, chlorfenvinphos, chlormephos, chlorpyrifos (-methyl/-ethyl), coumaphos, cyanofenphos, cyanophos, chlorfenvinphos, demeton-s-methyl, demeton-s-methylsulphone, dialifos, diazinon, dichlofenthion, dichlorvos/DDVP, dicrotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl o-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidon, phosphocarb, phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion)

2. Sodium channel modulators/blockers of voltage-gated sodium channels 2.1 pyrethroids (for example acrinathrin, allethrin (d-cis-trans, d-trans), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta-), cyphenothrin, DDT, deltamethrin, empenthrin (1R-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (1R-isomer), tralomethrin, transfluthrin, ZXI 8901, pyrethrins (pyrethrum))

2.2 oxadiazines (for example indoxacarb)

3. Acetylcholine receptor agonists/antagonists

3.1 chloronicotinyls/neonicotinoids (for example acetamiprid, clothianidin, dinotefuran, imidacloprid, nitenpyram, nithiazine, thiacloprid, thiamethoxam)

3.2 nicotine, bensultap, cartap

4. Acetylcholine receptor modulators

4.1 spinosyns (for example spinosad)

5. Antagonists of GABA-gated chloride channels

5.1 cyclodiene organochlorines (for example camphechlor, chlordane, endosulfan, gamma-HCH, HCH, heptachlor, lindane, methoxychlor)

5.2 fiproles (for example acetoprole, ethiprole, fipronil, vaniliprole)

6. Chloride channel activators

6.1 mectins (for example abamectin, avermectin, emamectin, emamectin-benzoate, ivermectin, milbemectin, milbemycin)

7. Juvenile hormone mimetics

(for example diofenolan, epofenonane, fenoxycarb, hydroprene, kinoprene, methoprene, pyriproxifen, triprene)

8. Ecdyson agonists/disruptors

8.1 diacylhydrazines (for example chromafenozide, halofenozide, methoxyfenozide, tebufenozide)

9. Chitin biosynthesis inhibitors

9.1 benzoylureas (for example bistrifluron, chlofluazuron, diflubenzuron, fluazuron, flucycloxuron, flufenoxuron, hexaflumuron, lufenuron, novaluron, noviflumuron, penfluron, teflubenzuron, triflumuron)

9.2 buprofezin

9.3 cyromazine

10. Inhibitors of oxidative phosphorylation, ATP disruptors

10.1 diafenthiuron

10.2 organotins (for example azocyclotin, cyhexatin, fenbutatin-oxide)

11. Decouplers of oxidative phosphorylation acting by interrupting the H-proton gradient

11.1 pyrroles (for example chlorfenapyr)

11.2 dinitrophenols (for example binapacryl, dinobuton, dinocap, DNOC)

12. Site-I electron transport inhibitors

12.1 METIs (for example fenazaquin, fenpyroximate, pyrimidifen, pyridaben, tebufenpyrad, tolfenpyrad)

12.2 hydramethylnone

12.3 dicofol

13. Site-II electron transport inhibitors

13.1 rotenone

14. Site-III electron transport inhibitors

14.1 acequinocyl, fluacrypyrim

15. Microbial disruptors of the insect gut membrane

Bacillus thuringiensis strains

16 Inhibitors offat synthesis

16.1 tetronic acids (for example spirodiclofen, spiromesifen)

16.2 tetramic acids [for example 3-(2,5-dimetbylphenyl)-8-methoxy-2-oxo-1-azaspiro[4.5]dec-3-en-4-yl ethyl carbonate (alias: carbonic acid, 3-(2,5-dimethylphenyl)-8-methoxy-2-oxo-1-azaspiro[4.5]dec-3-en-4-yl ethyl ester, CAS Reg. No.: 382608-10-8) and carbonic acid, cis-3-(2,5-dimethylphenyl)-8-methoxy-2-oxo-1-azaspiro[4.5]dec-3-en-4-yl ethyl ester (CAS Reg. No.: 203313-25-1)]

17. Carboxamides

(for example flonicamid)

18. Octopaminergic agonists

(for example amitraz)

19. Inhibitors of magnesium-stimulated ATPase

(for example propargite)

20. Phthalamides

(for example N²-[1,1-dimethyl-2-(methylsulphonyl)ethyl]-3-iodo-N¹-[2-methyl-4-[1,2,2,2-tetra-fluoro-1-trifluoromethyl)ethyl]phenyl]-1,2-benzenedicarboxamide (CAS Reg. No.: 272451-65-7), flubendiamide)

21. Nereistoxin analogues

(for example thiocyclam hydrogen oxalate, thiosultap-sodium)

22. Biologicals, hormones or pheromones

(for example azadirachtin, Bacillus spec., Beauveria spec., Codlemone, Metarrhizium spec., Paecilomyces spec., Thuringiensin, Verticillium spec.)

23. Active compounds with unknown or unspecific mechanisms of action

23.1 fumigants (for example aluminium phosphide, methyl bromide, sulphuryl fluoride)

23.2 selective antifeedants (for example cryolite, flonicamid, pymetrozine)

23.3 mite growth inhibitors (for example clofentezine, etoxazole, hexythiazox) 23.4 amidoflumet, benclothiaz, benzoximate, bifenazate, bromopropylate, buprofezin, chinomethionat, chlordimeform, chlorobenzilate, chloropicrin, clothiazoben, cycloprene, cyflumetofen, dicyclanil, fenoxacrim, fentrifanil, flubenzimine, flufenerim, flutenzin, gossyplure, hydramethylnone, japonilure, metoxadiazone, petroleum, piperonyl butoxide, potassium oleate, pyrafluprole, pyridalyl, pyriprole, sulfluramid, tetradifon, tetrasul, triarathene, verbutin,

furthermore the compound 3-methylphenyl propylcarbamate (Tsumacide Z), the compound 3-(5-chloro-3-pyridinyl)-8-(2,2,2-trifluoroethyl)-8-zabicyclo[3.2.1]octane-3-carbonitrile (CAS Reg. No. 185982-80-3) and the corresponding 3-endo-isomer (CAS Reg. No. 185984-60-5) (cf. WO 96/37494, WO 98/25923), and preparations which comprise insecticidally active plant extracts, nematodes, fungi or viruses.

A mixture with other known active compounds, such as herbicides, safeners and/or semiochemicals or with fertilizers and growth regulators, is also possible.

Depending on their particular physical and/or chemical properties, the active compounds according to the invention can be converted into the customary formulations, such as solutions, emulsions, suspensions, powders, dusts, foams, pastes, soluble powders, granules, aerosols, suspoemulsion concentrates, natural and synthetic materials impregnated with active compound and microencapsulations in polymeric substances and in coating compositions for seeds, and ULV cool and warm fogging formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers.

If the extender used is water, it is also possible to employ, for example, organic solvents as auxiliary solvents. Essentially, suitable liquid solvents are: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Liquefied gaseous extenders or carriers are to be understood as meaning liquids which are gaseous at standard temperature and under atmospheric pressure, for example aerosol propellants such as butane, propane, nitrogen and carbon dioxide.

Suitable solid carriers are: for example ammonium salts and ground natural minerals such as kaolins, clays, talc, chalk, quartz, attapulgite, montmorillonite or diatomaceous earth, and ground synthetic minerals such as finely divided silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignosulphite waste liquors and methylcellulose.

Tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids can be used in the formulations. Other possible additives are mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The active compound content of the use forms prepared from the commercial formulations may be varied within wide ranges. The concentration of active compound of the use forms for controlling animal pests, such as insects and acarids, may be from 0.0000001 to 95% by weight of active compound and is preferably from 0.0001 to 1% by weight. Application is in a customary manner adapted to the use forms.

The formulations for controlling unwanted phytopathogenic fungi generally comprise between 0.1 and 95% by weight of active compounds, preferably between 0.5 and 90%.

The active compounds used according to the invention can be used as such, in the form of their formulations or as the use forms prepared therefrom, such as ready-to-use solutions, emulsifiable concentrates, emulsions, suspensions, wettable powders, soluble powders, dusts and granules. They are used in a customary manner, for example by watering (drenching), drip irrigation, spraying, atomizing, broadcasting, dusting, foaming, painting, spreading-on, and as a powder for dry seed treatment, a solution for seed treatment, a water-soluble powder for seed treatment, a water-soluble powder for slurry treatment, or by encrusting etc.

The active compounds according to the invention can, in commercial formulations and in the use forms prepared from these formulations, be present as a mixture with other active compounds, such as insecticides, attractants, sterilants, bactericides, acaricides, nematicides, fungicides, growth regulators or herbicides.

When using the active compounds according to the invention, the application rates can be varied within a relatively wide range, depending on the kind of application. In the treatment of parts of plants, the application rates of active compounds are generally between 0.1 and 10 000 g/ha, preferably between 10 and 1000 g/ha. In the treatment of seed, the application rates of active compound combination are generally between 0.001 and 50 g per kilogram of seed, preferably between 0.01 and 10 g per kilogram of seed. In the treatment of the soil, the application rates of active compound combination are generally between 0.1 and 10 000 g/ha, preferably between 1 and 5000 g/ha.

The active compounds can be used as such, in the form of concentrates or in the form of generally customary formulations, such as powders, granules, solutions, suspensions, emulsions or pastes.

The formulations mentioned can be prepared in a manner known per se, for example by mixing the active compounds with at least one solvent or diluent, emulsifier, dispersant and/or binder or fixative, water repellent, if desired desiccants and UV stabilizers, and, if desired, colorants and pigments and other processing auxiliaries.

The good activity of the triazolopyrimidines of the formula (I) according to the invention is demonstrated by the examples below.

The invention is illustrated by the examples below. However, the invention is not limited to the examples.

### EXAMPLE 1

### Uromvces Test (Bean)/Protective

Solvents: 24.5 parts by weight of acetone
24.5 parts by weight of dimethylacetamide

Emulsifier: 1 part by weight of alkylaryl polyglycol ether

To produce a suitable preparation of active compound, 1 part by weight of active compound is mixed with the stated amounts of solvents and emulsifier, and the concentrate is diluted with water to the desired concentration.

To test for protective activity, young plants are sprayed with the preparation of active compound at the stated application rate. After the spray coating has dried on, the plants are inoculated with an aqueous spore suspension of the bean rust pathogen Uromyces appendiculatus and then remain in an incubation cabinet at about 20° C. and 100% relative atmospheric humidity for 1 day.

The plants are then placed in a greenhouse at about 21° C. and a relative atmospheric humidity of about 90%.

Evaluation is carried out 10 days after the inoculation. 0% means an efficacy which corresponds to that of the control, whereas an efficacy of 100% means that no infection is observed.

In this test, the compounds according to the invention listed in Examples 1, 3, 156, 238, 264, 271 and 274 exhibit, at an active compound concentration of 100 ppm, an efficacy of 70% or more.

### EXAMPLE 2

### Phakopsora Test (Soya Bean)/Protective

Solvent: 28.5 parts by weight of acetone

Emulsifier: 1.5 parts by weight of polyoxyethylene alkylphenyl ether

To produce a suitable preparation of active compound, 1 part by weight of active compound is mixed with the stated amounts of solvent and emulsifier, and the concentrate is diluted with water to the desired concentration.

To test for protective activity, young plants are sprayed with the preparation of active compound at the stated application rate. One day after the application, the plants are inoculated with an aqueous spore suspension of the soya bean rust pathogen Phakopsora pachyrhizi. The plants are then placed in a greenhouse at about 20° C. and a relative atmospheric humidity of about 80%.

Evaluation is carried out 11 days after the inoculation. 0% means an efficacy which corresponds to that of the control, whereas an efficacy of 100% means that no infection is observed.

In this test, the compounds according to the invention listed in Examples 1, 2, 3, 115, 156 exhibit, at an active compound concentration of 100 ppm, an efficacy of 80% or more.

### EXAMPLE 3

### Compounds Where the Amino Group is Not Cyclic, of the Formula Below

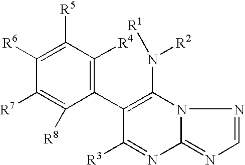

| | | | | | | | | | | Fraction | PF |
|---|---|---|---|---|---|---|---|---|---|---|---|
| | R¹ | R² | R³ | R⁴ | R⁵ | R⁶ | R⁷ | R⁸ | log p | No. | NUMBER |
| 1 | CH(CH₃)(CF₃) (S) | H | Cl | F | H | F | H | F | 2.87 | GBO489-1-1 | 0650111 |
| 2 | CH(CH₃)—C(CH₃)₃ (R) | H | Cl | F | H | F | H | F | 3.54 | HEC9545-1-1 | 1666091 |
| 3 | CH(CH₃)—CH(CH₃)₂ (R) | H | Cl | F | H | F | H | F | 3.2 | GBO1553-1-1 | 1666751 |
| 4 | sec-butyl | H | Cl | F | H | H | H | H | 2.73 | GLJ1084-1-1 | 1090189 |
| 5 | sec-butyl | H | Cl | F | H | H | H | F | 2.71 | GLJ1194-1-1 | 1104782 |
| 6 | sec-butyl | H | Cl | F | H | F | H | H | 2.85 | ELB14758-1-1 | 1192876 |
| 7 | sec-butyl | H | Cl | H | H | H | H | H | 2.78 | HERR3260-1-1 | 1618820 |
| 8 | sec-butyl | H | Cl | Cl | H | Cl | H | H | 3.54 | HERR3441-1-1 | 1619226 |
| 9 | sec-butyl | H | Cl | Cl | H | H | H | H | 2.94 | HERR3283-1-1 | 1619242 |
| 10 | 1,1,3,3-tetramethylbutyl | H | Cl | F | H | F | H | F | 4.32 | GLJ493-2-2 | 1203392 |
| 11 | 2-methylbutyl | H | Cl | F | H | F | H | F | 3.26 | GLJ442-1-1 | 1095810 |
| 12 | 3-fluoropropyl | H | Cl | F | H | F | H | F | 2.3 | GLJ642-1-1 | 1265334 |
| 13 | allyl | CH₂CH₃ | Cl | Cl | H | CF₃ | H | F | 4.06 | DLR6592-1-1 | 1191301 |
| 14 | allyl | CH₃ | Cl | F | H | F | H | H | 2.89 | ELB14779-1-1 | 1192885 |
| 15 | allyl | CH₂CH₃ | Cl | F | H | F | H | H | 3.19 | ELB14790-1-1 | 1192891 |
| 16 | allyl | CH₂CH₃ | Cl | Cl | H | H | H | H | 3.7 | HERR3410-1-1 | 1642848 |
| 17 | C(CH₃)₂—CF₃ | H | Cl | F | F | F | F | F | 3.75 | VAR4831-1-1 | 1266558 |
| 18 | CH₂CH₃ | CH₂CH₃ | Cl | F | H | H | H | H | 2.82 | GLJ1068-1-1 | 1090180 |
| 19 | CH₂CH₃ | CH₂CH₃ | Cl | F | H | H | H | F | | GLJ1178-1-1 | 1117655 |
| 20 | CH₂CH₃ | CH₂CH₃ | Cl | Cl | H | CF₃ | H | F | | DLR649-1-1 | 1175436 |
| 21 | CH₂CH₃ | H | Cl | F | H | CF₃ | H | Cl | 3.1 | GYR15050-1-1 | 1191284 |
| 22 | CH₂CH₃ | CH₂CH₃ | Cl | F | F | F | F | F | 3.44 | VAR4835-1-1 | 1199469 |
| 23 | CH₂CH₃ | H | Cl | F | H | H | H | H | 2.13 | GLJ1059-1-1 | 1204185 |
| 24 | CH₂CH₃ | H | Cl | F | H | H | H | F | 2.14 | GLJ1169-1-1 | 1235227 |
| 25 | CH₂CH₃ | H | Cl | F | F | F | F | F | 2.72 | VAR4826-1-1 | 1266556 |
| 26 | CH₂CH₃ | CH₂CH₃ | Cl | F | H | F | H | F | 3.05 | HEC9169-1-1 | 1387408 |
| 27 | CH₂CH₃ | CH₂CH₃ | Cl | H | H | H | H | H | | RPA431107-1-1 | 2654888 |
| 28 | CH₂CH₃ | CH₂CH₃ | Cl | Cl | H | H | H | F | | RPA430330-1-1 | 5157556 |
| 29 | CH(CH₃)(CF₃) | H | Cl | F | H | F | H | F | 2.88 | HEC8717-1-2 | 0640885 |
| 30 | CH(CH₃)(CF₃) | H | Cl | Cl | H | H | H | F | 2.85 | GBO463-1-1 | 0659209 |
| 31 | CH(CH₃)(CF₃) (S) | H | Cl | Cl | H | H | H | F | 2.85 | GBO464-1-1 | 0659210 |
| 32 | CH(CH₃)(CF₃) | H | Cl | F | F | H | F | H | 2.93 | GBO454-1-1 | 0662481 |
| 33 | CH(CH₃)(CF₃) (S) | H | Cl | F | F | H | F | H | 3.04 | GBO810-3-1 | 0662525 |
| 34 | CH(CH₃)(CF₃) (S) | H | Cl | Cl | H | CF₃ | H | F | | GBO1121-1-2 | 1000564 |
| 35 | CH(CH₃)(CF₃) (S) | H | Cl | CH₃ | H | CH₃ | H | CH₃ | 3.55 | HEC8698-3-1 | 1011601 |
| 36 | CH(CH₃)(CF₃) (S) | H | Cl | Cl | H | CF₃ | H | Cl | 3.79 | GBO1045-1-1 | 1013217 |
| 37 | CH(CH₃)(CF₃) (S) | H | Cl | Cl | H | OCF₃ | H | Cl | 3.89 | GBO1046-1-1 | 1013219 |
| 38 | CH(CH₃)(CF₃) (S) | H | Cl | SCH₃ | H | F | H | F | 3.17 | GBO1061-1-3 | 1043682 |
| 39 | CH(CH₃)(CF₃) (S) | H | Cl | CF₃ | H | H | CF₃ | H | 3.51 | GBO1048-1-1 | 1054432 |
| 40 | CH(CH₃)(CF₃) (S) | H | Cl | H | CF₃ | H | H | Cl | 3.4 | GBO1047-1-1 | 1054433 |
| 41 | CH(CH₃)(CF₃) (S) | H | Cl | F | F | CF₃ | H | F | 3.6 | GBO1064-1-1 | 1055815 |
| 42 | CH(CH₃)(CF₃) (S) | H | Cl | F | F | CF₃ | H | H | 3.52 | GBO1065-1-2 | 1058810 |
| 43 | CH(CH₃)(CF₃) | H | Cl | H | Cl | F | H | H | 3.18 | HEC8809-1-1 | 1065368 |
| 44 | CH(CH₃)(CF₃) (S) | H | Cl | Cl | CF₃ | H | F | Cl | 3.74 | HEC8762-1-2 | 1065974 |
| 45 | CH(CH₃)(CF₃) (S) | H | Cl | F | H | CF₃ | H | H | 3.33 | HEC8771-1-2 | 1087592 |
| 46 | CH(CH₃)(CF₃) | H | Cl | Cl | H | F | H | H | 3.04 | GYR9635-1-2 | 1097071 |
| 47 | CH(CH₃)(CF₃) | H | Cl | F | H | H | H | F | 2.64 | GLJ456-1-1 | 1188994 |
| 48 | CH(CH₃)(CF₃) | H | Cl | F | F | F | F | F | 3.3 | VAR4845-1-1 | 1199473 |
| 49 | CH(CH₃)(CF₃) | H | Cl | F | H | H | H | H | 2.69 | GLJ1078-1-1 | 1204189 |
| 50 | CH(CH₃)(CF₃) (S) | H | Cl | Cl | H | H | S—CF₃ | H | 3.78 | HEC8973-1-1 | 1264732 |
| 51 | CH(CH₃)(CF₃) (S) | H | Cl | Cl | CF₃ | H | H | H | 3.36 | HEC8972-1-1 | 1264762 |
| 52 | CH(CH₃)(CF₃) (S) | H | Cl | F | H | F | H | H | 2.81 | ELB14385-1-1 | 1265540 |
| 53 | CH(CH₃)(CF₃) (S) | H | Cl | Cl | H | H | H | Cl | 3.02 | HEC8976-1-2 | 1265911 |
| 54 | CH(CH₃)(CF₃) (S) | H | Cl | CF₃ | H | F | H | F | 3.16 | HEC8974-1-1 | 1265974 |
| 55 | CH(CH₃)(CF₃) (S) | H | Cl | —O—CF₂—O— | | H | H | H | 3.16 | HEC8975-1-2 | 1266011 |
| 56 | CH(CH₃)(CF₃) | H | Cl | F | H | CF₃ | H | F | 3.09 | HEC8986-1-1 | 1266104 |
| 57 | CH(CH₃)(CF₃) | H | Cl | Cl | H | H | H | H | 2.88 | KBR9563-1-1 | 1563183 |
| 58 | CH(CH₃)(CF₃) (S) | H | Cl | Cl | H | H | H | H | 2.87 | KBR9564-1-1 | 1563184 |
| 59 | CH(CH₃)(CF₃) (S) | H | Cl | CF₃ | H | F | H | H | 3.07 | HEC9388-1-1 | 1613068 |
| 60 | CH(CH₃)(CF₃) (R) | H | Cl | F | H | F | H | F | 2.84 | GBO1653-1-1 | 1632160 |
| 61 | CH(CH₃)(CF₃) (R) | H | Cl | Cl | H | F | H | H | 3 | GBO1663-1-1 | 1644665 |
| 62 | CH(CH₃)(CF₃) (S) | H | Cl | F | H | H | F | H | 2.74 | HEC9974-1-1 | 4200044 |
| 63 | CH(CH₃)(CF₃) | H | Cl | Cl | H | H | H | F | | RPA430331-1-1 | 5157609 |
| 64 | CH(CH₃)(CF₃) | H | Cl | Cl | H | H | H | F | | RPA430329-1-1 | 5157610 |
| 65 | CH(CH₃)(CF₃) | H | Br | Cl | H | OCF₃ | H | Cl | 3.92 | MAT17972-1-3 | 1188711 |
| 66 | CH(CH₃)(CF₃) | H | Br | F | H | F | H | F | 2.9 | MAT17982-1-1 | 1190327 |
| 67 | CH(CH₃)—C(CH₃)₃ | H | Cl | F | H | F | H | F | 3.53 | HEC9541-1-1 | 1661037 |
| 68 | CH(CH₃)—C(CH₃)₃ (S) | H | Cl | F | H | F | H | F | 3.54 | HEC9544-1-1 | 1666100 |
| 69 | CH(CH₃)—C(CH₃)₃ | H | Cl | F | H | H | H | Cl | 3.58 | HEC9548-1-1 | 1666119 |
| 70 | CH(CH₃)—C(CH₃)₃ (R) | H | Cl | F | H | H | H | Cl | 3.58 | HEC9590-1-1 | 1692767 |
| 71 | CH(CH₃)—C(CH₃)₃ (S) | H | Cl | F | H | H | H | Cl | 3.63 | HEC9591-1-1 | 1692818 |
| 72 | CH(CH₃)—C(CH₃)₃ (R) | H | Cl | F | H | H | F | H | 3.38 | HEC9970-1-1 | 1905293 |
| 73 | CH(CH₃)—CH(CH₃)₂ | H | Cl | F | H | F | H | F | 3.2 | HERR3414-1-1 | 1618203 |
| 74 | CH(CH₃)—CH(CH₃)₂ | H | Cl | H | H | H | H | H | 3.14 | HERR3261-1-2 | 1618821 |
| 75 | CH(CH₃)—CH(CH₃)₂ | H | Cl | F | H | F | H | H | | HERR3438-1-1 | 1619483 |
| 76 | CH(CH₃)—CH(CH₃)₂ | H | Cl | Cl | H | Cl | H | H | | HERR3443-1-1 | 1619485 |
| 77 | CH(CH₃)—CH(CH₃)₂ (S) | H | Cl | F | H | F | H | F | 3.17 | GBO1578-1-2 | 1688392 |
| 78 | CH(CH₃)—CH(CH₃)₂ (R) | H | Cl | F | H | H | F | H | 3.05 | HEC9971-1-1 | 1904954 |
| 79 | CH(CH₃)—CH(CH₃)₂ (R) | H | CH₃ | Cl | H | H | H | F | 2.7 | GBO1595-1-2 | 1709794 |
| 80 | CH(CH₃)—CH₂— | H | Cl | F | H | F | H | F | 3.59 | GLJ443-1-1 | 1095811 |
| | CH(CH₃)₂ | | | | | | | | | | |
| 81 | CH(CH₃)—CH₂— | H | Cl | F | H | F | H | H | 3.53 | ELB14840-1-1 | 1197214 |
| | CH(CH₃)₂ | | | | | | | | | | |
| 82 | CH₃ | H | Cl | F | H | H | H | F | 1.84 | GLJ415-1-1 | 1053792 |
| 83 | CH₃ | H | Cl | F | H | F | H | F | 2.01 | HEC8780-1-1 | 1089328 |
| 84 | CH₃ | H | Cl | F | F | F | F | F | 2.41 | VAR4838-1-1 | 1199471 |
| 85 | CH₃ | CH₃ | Cl | F | H | H | H | H | 2.18 | GLJ1057-1-1 | 1204184 |
| 86 | CH₃ | H | Cl | F | H | H | H | H | 1.86 | GLJ1071-1-1 | 1204187 |
| 87 | CH₃ | CH₃ | Cl | F | H | H | H | F | 2.19 | GLJ1167-1-1 | 1235223 |
| 88 | CH₃ | CH₃ | Cl | Cl | H | H | H | F | | YOY1436-0-0 | 5553314 |
| 89 | CHCH₃CH₂CH₂Ph | H | Cl | Cl | H | H | H | H | | YRC8868-1-1 | 0525687 |
| 90 | CH₂—C(CH₃)═CH₂ | CH₂CH₃ | Cl | F | H | F | H | F | 3.6 | GBO1056-1-1 | 1038802 |
| 91 | CH₂—C(CH₃)═CH₂ | H | Cl | F | H | H | H | H | 2.48 | GLJ1079-1-1 | 1090186 |
| 92 | CH₂—C(CH₃)═CH₂ | H | Cl | F | H | H | H | F | | GLJ1189-1-1 | 1117662 |
| 93 | CH₂—C(CH₃)═CH₂ | CH₂CH₃ | Cl | F | H | F | H | H | 3.54 | ELB14383-1-1 | 1122410 |
| 94 | CH₂—C(CH₃)═CH₂ | H | Cl | F | H | F | H | F | 2.63 | GLJ453-1-1 | 1147570 |
| 95 | CH₂—C(CH₃)═CH₂ | CH₂CH₃ | Cl | F | H | H | H | F | 3.42 | GLJ454-1-1 | 1148350 |
| 96 | CH₂—C(CH₃)═CH₂ | CH₃ | Cl | Cl | H | CF₃ | H | F | 4.05 | DLR6589-1-1 | 1191298 |
| 97 | CH₂—C(CH₃)═CH₂ | H | Cl | F | H | F | H | H | 2.6 | ELB14770-1-1 | 1192882 |
| 98 | CH₂—C(CH₃)═CH₂ | CH₃ | Cl | F | H | F | H | H | 3.21 | ELB14787-1-1 | 1192890 |
| 99 | CH₂—C(CH₃)═CH₂ | CH₂CH₃ | Cl | Cl | H | H | H | Cl | 3.92 | HEC8971-1-1 | 1262792 |
| 100 | CH₂—C(CH₃)═CH₂ | CH₂CH₃ | Cl | H | CF₃ | H | H | Cl | 4.12 | HEC8968-1-1 | 1264652 |
| 101 | CH₂—C(CH₃)═CH₂ | CH₂CH₃ | Cl | —O—CF₂—O— | | H | H | H | 3.9 | HEC8970-1-1 | 1264712 |
| 102 | CH₂—C(CH₃)═CH₂ | CH₂CH₃ | Cl | Cl | CF₃ | H | H | H | 4.12 | HEC8967-1-1 | 1265252 |
| 103 | CH₂—C(CH₃)═CH₂ | CH₂CH₃ | Cl | Cl | H | H | S—CF₃ | H | 4.67 | HEC8969-1-1 | 1265283 |
| 104 | CH₂—C(CH₃)═CH₂ | H | Cl | F | F | F | F | F | 3.09 | VAR4846-1-1 | 1286565 |
| 105 | CH₂—C(CH₃)═CH₂ | CH₂CH₃ | Cl | Cl | H | H | H | H | 3.69 | HEC9392-1-1 | 1612044 |
| 106 | CH₂—C(CH₃)═CH₂ | CH₂CH₃ | Cl | H | H | H | H | H | 3.44 | HERR3273-1-1 | 1619030 |
| 107 | CH₂—C(CH₃)₃ | H | Cl | F | H | F | H | H | 3.23 | ELB14757-1-1 | 1192875 |
| 108 | CH₂—C(CH₃)₃ | H | Cl | Cl | H | Cl | H | H | 3.98 | HERR3440-1-1 | 1619225 |
| 109 | CH₂—C(CH₃)₃ | H | Cl | H | H | H | H | H | 3.17 | HERR3291-1-1 | 1619323 |
| 110 | CH₂—C(CH₃)₃ | H | Cl | Cl | H | F | H | H | 3.5 | HEC10129-1-1 | 4269572 |
| 111 | CH₂—CF₃ | H | Cl | F | H | H | H | H | 2.37 | GLJ1075-1-1 | 1204188 |
| 112 | CH₂—CF₃ | H | Cl | F | H | H | H | F | 2.39 | GLJ1185-1-1 | 1235238 |
| 113 | CH₂—CF₃ | H | Cl | F | F | F | F | F | 3 | VAR4842-1-1 | 1266563 |
| 114 | CH₂—CF₃ | H | Cl | F | H | F | H | H | 2.55 | ELB14767-1-1 | 1294214 |
| 115 | CH₂—CF₃ | H | Cl | F | H | F | H | F | | RPA428453-1-1 | 2620774 |
| 116 | CH₂—CH₂—CF₃ | H | Cl | F | H | H | H | F | | GLJ1190-1-1 | 1117663 |
| 117 | CH₂—CH₂—CF₃ | H | Cl | F | H | F | H | H | 2.65 | ELB14760-1-1 | 1192877 |
| 118 | CH₂—CH₂—CF₃ | H | Cl | F | H | H | H | H | 2.55 | GLJ1080-1-1 | 1204190 |
| 119 | CH₂—CH₂—Cl | CH₃ | Cl | F | H | F | H | H | 2.73 | ELB14785-1-1 | 1192889 |
| 120 | i-butyl | CH₃ | Cl | Cl | H | CF₃ | H | F | 4.17 | DLR6590-1-1 | 1191299 |
| 121 | i-butyl | H | Cl | F | H | F | H | H | 2.86 | ELB14755-1-1 | 1192873 |
| 122 | i-butyl | CH₃ | Cl | F | H | F | H | H | 3.31 | ELB14784-1-1 | 1192888 |
| 123 | i-butyl | H | Cl | Cl | H | H | H | F | 2.91 | HEC9312-1-1 | 1537123 |
| 124 | i-butyl | H | Cl | Cl | H | F | H | H | 3.1 | HEC9334-1-1 | 1564712 |
| 125 | i-butyl | H | Cl | F | H | F | H | F | 2.89 | HEC9335-1-1 | 1564723 |
| 126 | i-butyl | H | Cl | Cl | H | H | H | H | 2.97 | HERR3282-1-2 | 1617283 |
| 127 | i-butyl | H | Cl | H | H | H | H | H | 2.79 | HERR3259-1-1 | 1618819 |
| 128 | i-propyl | H | Cl | Cl | H | Cl | H | H | 3.23 | KDI2563-0-0 | 0114256 |
| 129 | i-propyl | H | Cl | H | H | F | H | H | 2.57 | KDI2562-0-0 | 0114484 |
| 130 | i-propyl | H | Cl | H | F | H | H | H | 2.53 | KDI2564-0-0 | 0114485 |
| 131 | i-propyl | H | Cl | Cl | H | H | H | H | 2.65 | KDI2565-0-0 | 0114486 |
| 132 | i-propyl | H | Cl | Cl | H | H | H | Cl | | KYO5110-1-1 | 0758959 |
| 133 | i-propyl | H | Cl | Cl | H | H | H | F | | KYO5169-1-1 | 0760561 |
| 134 | i-propyl | H | Cl | H | Cl | H | H | H | | MIY696-1-1 | 0827358 |
| 135 | i-propyl | H | Cl | H | H | Cl | H | H | | MIY667-1-1 | 0917020 |
| 136 | i-propyl | H | Cl | H | H | CF₃ | H | H | | MIY668-1-1 | 0917052 |
| 137 | i-propyl | H | Cl | H | H | CH₃ | H | H | | MIY693-1-1 | 0917100 |
| 138 | i-propyl | H | Cl | Cl | CF₃ | H | F | Cl | 3.45 | HEC8760-1-1 | 1058971 |
| 139 | i-propyl | H | Cl | F | H | CF₃ | H | H | 3.06 | HEC8763-1-1 | 1065219 |
| 140 | i-propyl | H | Cl | H | Cl | F | H | H | 2.9 | HEC8810-1-1 | 1065376 |
| 141 | i-propyl | H | Cl | F | H | H | H | H | 2.42 | GLJ1067-1-1 | 1090179 |
| 142 | i-propyl | H | Cl | Cl | H | F | H | H | 2.79 | GYR9634-1-1 | 1097070 |
| 143 | i-propyl | H | Cl | F | H | H | H | F | | GLJ1177-1-1 | 1117654 |
| 144 | i-propyl | H | Cl | F | F | F | F | F | 3.05 | VAR4834-1-1 | 1199468 |
| 145 | i-propyl | H | Cl | F | H | F | H | H | 2.56 | ELB14763-1-1 | 1294212 |
| 146 | i-propyl | H | Cl | CH₃ | H | H | H | H | | KYO5610-1-1 | 1525323 |
| 147 | i-propyl | H | Cl | H | H | H | H | H | 2.45 | HERR3256-1-1 | 1618817 |
| 148 | i-propyl | H | CN | H | H | CH₃ | H | H | | KYO5349-1-1 | 0989866 |
| 149 | n-butyl | H | Cl | F | H | F | H | H | 2.9 | ELB14756-1-1 | 1192874 |
| 150 | n-propyl | H | Cl | F | H | H | H | H | 2.43 | GLJ1065-1-1 | 1090178 |
| 151 | n-propyl | H | Cl | F | H | H | H | F | | GLJ1175-1-1 | 1117653 |
| 152 | n-propyl | H | Cl | F | F | F | F | F | 3.05 | VAR4832-1-1 | 1199466 |
| 153 | t-butyl | H | Cl | Cl | H | CF₃ | H | F | 3.9 | GYR15057-1-1 | 1191291 |
| 154 | t-butyl | H | Cl | F | H | F | H | F | 3.05 | GLJ627-1-1 | 1253182 |
| 155 | CH₃ | CH₃ | Cl | F | F | F | F | F | 2.74 | VAR4824-1-1 | 1199464 |

### EXAMPLE 4

### Compounds Where the Amino Group is Not Cyclic, of the Formula Below

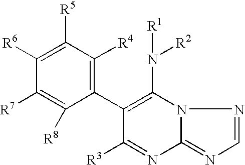

| EX | | | | | | | | | Fraction | PF |
|---|---|---|---|---|---|---|---|---|---|---|
| NO. | NR¹R² | R³ | R⁴ | R⁵ | R⁶ | R⁷ | R⁸ | log p | No. | NUMBER |
| 156 | 4-methylpiperidin-1-yl | Cl | F | H | F | H | F | 3.6 | GBO827-1-1 | 0741391 |
| 157 | isoxazolidin-2-yl | Cl | F | H | H | H | F | 2.07 | GBO126-1-1 | 0597401 |
| 158 | 4-methylpiperidin-1-yl | Cl | Cl | H | H | H | F | 3.68 | GBO800-3-2 | 0650104 |
| 159 | piperidin-1-yl | Cl | Cl | H | H | H | Cl | | KYO5129-1-1 | 0758953 |
| 160 | 4-(trifluoromethyl)piperidin-1-yl | Cl | F | H | F | H | F | 3.41 | GBO1014-1-1 | 0827882 |
| 161 | morpholin-4-yl | Cl | CH₃ | H | CH₃ | H | CH₃ | 2.8 | HEC8723-1-1 | 1011221 |
| 162 | 2,6-dimethylmorpholin-4-yl | Cl | F | H | H | H | H | 2.67 | GLJ1058-1-1 | 1090174 |
| 163 | pyrrolidin-1-yl | Cl | F | H | H | H | H | 2.49 | GLJ1060-1-1 | 1090175 |
| 164 | piperidin-1-yl | Cl | F | H | H | H | H | 3.01 | GLJ1063-1-1 | 1090177 |
| 165 | thiomorpholin-4-yl | Cl | F | H | H | H | H | 2.68 | GLJ1074-1-1 | 1090183 |
| 166 | 4-(trifluoromethyl)piperidin-1-yl | Cl | F | H | H | H | H | 3.23 | GLJ1076-1-1 | 1090184 |
| 167 | 2,6-dimethylmorpholin-4-yl | Cl | F | H | H | H | F | | GLJ1168-1-1 | 1117650 |
| 168 | pyrrolidin-1-yl | Cl | F | H | H | H | F | | GLJ1170-1-1 | 1117651 |
| 169 | piperidin-1-yl | Cl | F | H | H | H | F | | GLJ1173-1-1 | 1117652 |
| 170 | morpholin-4-yl | Cl | F | H | H | H | F | | GLJ1179-1-1 | 1117656 |
| 171 | thiomorpholin-4-yl | Cl | F | H | H | H | F | | GLJ1184-1-1 | 1117659 |
| 172 | 4-(trifluoromethyl)piperidin-1-yl | Cl | F | H | H | H | F | | GLJ1186-1-1 | 1117660 |
| 173 | piperidin-1-yl | Cl | F | H | F | H | F | 3.53 | GLJ480-1-1 | 1189081 |
| 174 | 4-methylpiperazin-1-yl | Cl | Cl | H | CF₃ | H | F | 1.68 | GYR15048-1-1 | 1191282 |
| 175 | morpholin-4-yl | Cl | Cl | H | CF₃ | H | F | 3.07 | GYR15049-1-1 | 1191283 |
| 176 | pyrrolidin-1-yl | Cl | Cl | H | CF₃ | H | F | 3.5 | GYR15051-1-1 | 1191285 |
| 177 | piperidin-1-yl | Cl | Cl | H | CF₃ | H | F | 4.03 | GYR15052-1-1 | 1191286 |
| 178 | 4-(trifluoromethyl)piperidin-1-yl | Cl | Cl | H | CF₃ | H | F | 4.18 | GYR15056-1-1 | 1191290 |
| 179 | 3,6-dihydropyridin-1(2h)-yl | Cl | Cl | H | CF₃ | H | F | 3.85 | DLR6591-1-1 | 1191300 |
| 180 | 3,5-dimethylpiperidin-1-yl | Cl | Cl | H | CF₃ | H | F | 4.79 | DLR6594-1-1 | 1191303 |
| 181 | 3-methylpiperidin-1-yl | Cl | Cl | H | CF₃ | H | F | 4.46 | DLR6595-1-1 | 1191304 |
| 182 | 4-methylpiperidin-1-yl | Cl | Cl | H | CF₃ | H | F | 4.37 | DLR6596-1-1 | 1191305 |
| 183 | 5-methyl-3,6-dihydropyridin-1(2h)-yl | Cl | Cl | H | CF₃ | H | F | 4.23 | DLR6598-1-1 | 1191307 |
| 184 | 2-methylpyrrolidin-1-yl | Cl | F | H | F | H | H | 2.99 | ELB14803-1-1 | 1197192 |
| 185 | pyrrolidin-1-yl | Cl | F | H | F | H | H | 2.62 | ELB14808-1-1 | 1197193 |
| 186 | 3,6-dihydropyridin-1(2h)-yl | Cl | F | H | F | H | H | 2.94 | ELB14810-1-1 | 1197195 |
| 187 | 3,5-dimethylpiperidin-1-yl | Cl | F | H | F | H | H | 3.9 | ELB14812-1-1 | 1197197 |
| 188 | 2-methylpiperidin-1-yl | Cl | F | H | F | H | H | 3.44 | ELB14813-1-1 | 1197198 |
| 189 | 3-methylpiperidin-1-yl | Cl | F | H | F | H | H | 3.52 | ELB14814-1-1 | 1197199 |
| 190 | 4-methylpiperidin-1-yl | Cl | F | H | F | H | H | 3.54 | ELB14815-1-1 | 1197200 |
| 191 | 4.4-dimethylpiperidin-1-yl | Cl | F | H | F | H | H | 3.8 | ELB14818-1-1 | 1197202 |
| 192 | 5-methyl-3,6-dihydropyridin-1(2H)-yl | Cl | F | H | F | H | H | 3.3 | ELB14821-1-1 | 1197205 |
| 193 | 4-(trifluoromethyl)piperidin-1-yl | Cl | F | H | F | H | H | 3.34 | ELB14825-1-1 | 1197208 |
| 194 | piperidin-1-yl | Cl | F | H | F | H | H | 3.14 | ELB14829-1-1 | 1197209 |
| 195 | morpholin-4-yl | Cl | F | H | F | H | H | 2.19 | ELB14830-1-1 | 1197210 |
| 196 | thiomorpholin-4-yl | Cl | F | H | F | H | H | 2.8 | ELB14832-1-1 | 1197211 |
| 197 | 4-methylpiperazin-1-yl | Cl | F | F | F | F | F | 1.43 | VAR4823-1-1 | 1199463 |
| 198 | piperidin-1-yl | Cl | F | F | F | F | F | 3.61 | VAR4830-1-1 | 1199465 |
| 199 | morpholin-4-yl | Cl | F | F | F | F | F | 2.69 | VAR4836-1-1 | 1199470 |
| 200 | morpholin-4-yl | Cl | F | H | H | H | H | 2.09 | GLJ1069-1-1 | 1204186 |
| 201 | 1,2-oxazinan-2-yl | Cl | F | H | F | H | F | 2.92 | GLJ616-1-2 | 1211110 |
| 202 | 2-(trifluoromethyl)piperidin-1-yl | Cl | F | H | H | H | F | 3.11 | GLJ1183-1-1 | 1235236 |
| 203 | isoxazolidin-2-yl | Cl | F | H | F | H | F | 2.4 | GLJ644-1-1 | 1265292 |
| 204 | 1,2-oxazinan-2-yl | Cl | Cl | H | F | H | H | 3.11 | GLJ645-1-1 | 1265703 |
| 205 | 1,2-oxazinan-2-yl | Cl | F | H | F | H | H | 2.84 | GLJ646-1-1 | 1265704 |
| 206 | 2,6-dimethylmorpholin-4-yl | Cl | F | F | F | F | F | 3.33 | VAR4825-1-1 | 1266555 |
| 207 | pyrrolidin-1-yl | Cl | F | F | F | F | F | 3.11 | VAR4827-1-1 | 1266557 |
| 208 | 2-(trifluoromethyl)piperidin-1-yl | Cl | F | F | F | F | F | 4.09 | VAR4840-1-1 | 1266561 |
| 209 | thiomorpholin-4-yl | Cl | F | F | F | F | F | 3.29 | VAR4841-1-1 | 1266562 |
| 210 | 2-(trifluoromethyl)pyrrolidin-1-yl | Cl | F | H | F | H | H | 3.2 | ELB14805-1-1 | 1266572 |
| 211 | 2,6-dimethylmorpholin-4-yl | Cl | F | H | F | H | H | 2.85 | ELB14828-1-1 | 1266575 |
| 212 | tetrahydropyridazin-1(2H)-yl | Cl | F | H | F | H | F | 2.68 | MAT18237-1-1 | 1273370 |
| 213 | 4,5-dihydro-1H-pyrazol-1-yl | Cl | F | H | F | H | F | 2.34 | HEC8994-1-1 | 1273514 |
| 214 | tetrahydropyridazin-1(2H)-yl | Cl | Cl | H | H | H | F | 2.67 | HEC8993-1-1 | 1277398 |
| 215 | tetrahydropyridazin-1(2H)-yl | Cl | —O—CF2—O— | | H | H | H | 2.97 | HEC8998-1-1 | 1290422 |
| 216 | tetrahydropyridazin-1(2H)-yl | Cl | Cl | H | H | S—CF₃ | H | 3.72 | HEC8995-1-1 | 1290426 |
| 217 | tetrahydropyridazin-1(2H)-yl | Cl | H | CF₃ | H | H | Cl | 3.25 | HEC8997-1-1 | 1290455 |
| 218 | tetrahydropyridazin-1(2H)-yl | Cl | Cl | CF₃ | H | H | H | 3.16 | HEC8996-1-1 | 1290457 |
| 219 | tetrahydropyridazin-1(2H)-yl | Cl | Cl | H | OCF₃ | H | Cl | 3.81 | MAT18245-1-1 | 1297163 |
| 220 | tetrahydropyridazin-1(2H)-yl | Cl | Cl | CF₃ | H | F | Cl | 3.64 | HEC9136-1-1 | 1297303 |
| 221 | tetrahydropyridazin-1(2H)-yl | Cl | Cl | H | H | H | Cl | 2.88 | HEC9135-1-1 | 1297332 |
| 222 | piperidin-1-yl | Cl | CH₃ | H | H | H | H | | KYO5597-1-1 | 1315391 |
| 223 | 3-methylisoxazolidin-2-yl | Cl | F | H | F | H | F | 2.76 | GLJ803-1-2 | 1463521 |
| 224 | 3,6-dihydropyridazin-1(2H)-yl | Cl | F | H | F | H | F | 2.53 | HEC9178-1-1 | 1478565 |
| 225 | 1,2-oxazinan-2-yl | Cl | F | H | H | H | F | 2.68 | GLJ853-1-1 | 1504480 |
| 226 | 3-methyl-1,2-oxazinan-2-yl | Cl | F | H | F | H | F | 3.23 | GLJ660-3-2 | 1513383 |
| 227 | 1,2-oxazinan-2-yl | Cl | Cl | H | H | H | F | 2.92 | GLJ859-1-2 | 1525806 |
| 228 | tetrahydropyridazin-1(2H)-yl | Cl | F | H | H | H | F | 2.47 | HEC9197-1-1 | 1527144 |
| 229 | tetrahydropyridazin-1(2H)-yl | Cl | F | H | F | H | H | 2.57 | HEC9198-1-1 | 1527209 |
| 230 | 1,2-oxazinan-2-yl | Cl | Cl | H | H | H | H | 2.87 | GLJ860-2-2 | 1527908 |
| 231 | tetrahydropyridazin-1(2H)-yl | Cl | Cl | H | H | H | H | 2.61 | HEC9199-1-1 | 1527964 |
| 232 | 3-methylisoxazolidin-2-yl | Cl | Cl | H | H | H | F | 2.74 | GLJ864-1-2 | 1529783 |
| 233 | tetrahydropyridazin-1(2H)-yl | Cl | Cl | H | F | H | H | 2.8 | HEC9307-1-1 | 1533127 |
| 234 | 3-methyl-1,2-oxazinan-2-yl | Cl | F | H | H | H | F | 2.96 | GLJ866-1-2 | 1537103 |
| 235 | tetrahydropyridazin-1(2H)-yl | Cl | CF₃ | H | F | H | F | 3.06 | HEC9328-1-1 | 1561922 |
| 236 | 3-methyl-1,2-oxazinan-2-yl | Cl | Cl | H | F | H | H | 3.59 | GLJ886-2-3 | 1562228 |
| 237 | 3-methyl-1,2-oxazinan-2-yl | Cl | Cl | H | H | H | H | 3.17 | GLJ877-2-5 | 1562947 |
| 238 | tetrahydropyridazin-1(2H)-yl | Cl | F | H | CF₃ | H | F | 3.26 | HEC9336-1-1 | 1563023 |
| 239 | tetrahydropyridazin-1(2H)-yl | Cl | Cl | H | Cl | H | H | 3.22 | HEC9329-1-1 | 1563146 |
| 240 | 3,6-dihydro-2H-1,2-oxazin-2-yl | Cl | F | H | F | H | F | | GLJ2521-1-1 | 1563477 |
| 241 | 3,6-dihydro-2H-1,2-oxazin-2-yl | Cl | Cl | H | H | H | H | 2.74 | GLJ2531-1-2 | 1573585 |
| 242 | 3,6-dihydro-2H-1,2-oxazin-2-yl | Cl | Cl | H | F | H | H | 2.93 | GLJ2532-1-2 | 1573586 |
| 243 | 3,6-dihydro-2H-1,2-oxazin-2-yl | Cl | Cl | H | H | H | F | 2.78 | GLJ2533-1-2 | 1574062 |
| 244 | 5,6-dihydropyridazin-1(4H)-yl | Cl | Cl | H | H | H | F | 2.58 | HEC9097-2-1 | 1579947 |
| 245 | 1,2-oxazinan-2-yl | Cl | Cl | H | Cl | H | H | 3.51 | GLJ2539-1-2 | 1580005 |
| 246 | 6-methyl-3,6-dihydro-2H-1,2-oxazin-2-yl | Cl | F | H | F | H | F | 3.12 | GLJ2545-1-2 | 1584786 |
| 247 | pyrrolidin-1-yl | Cl | Cl | H | H | H | H | 2.72 | HERR3286-1-2 | 1617280 |
| 248 | 2-methylpiperidin-1-yl | Cl | Cl | H | H | H | H | 3.6 | HERR3412-1-1 | 1618183 |
| 249 | tetrahydropyridazin-1(2H)-yl | Cl | CF₃ | H | F | H | H | 2.98 | HEC9386-1-1 | 1618653 |
| 250 | pyrrolidin-1-yl | Cl | H | H | H | H | H | 2.5 | HERR3262-1-1 | 1619026 |
| 251 | piperidin-1-yl | Cl | H | H | H | H | H | 3.05 | HERR3264-1-1 | 1619027 |
| 252 | morpholin-4-yl | Cl | H | H | H | H | H | 2.03 | HERR3265-1-1 | 1619028 |
| 253 | 4-methylpiperidin-1-yl | Cl | H | H | H | H | H | 3.47 | HERR3272-1-1 | 1619029 |
| 254 | morpholin-4-yl | Cl | Cl | H | Cl | H | H | 2.78 | HERR3444-1-1 | 1619227 |
| 255 | 2-methylpyrrolidin-1-yl | Cl | Cl | H | H | H | H | 3.1 | HERR3411-1-1 | 1619236 |
| 256 | 4-methylpiperidin-1-yl | Cl | Cl | H | H | H | H | 3.71 | HERR3287-1-2 | 1619283 |
| 257 | piperidin-1-yl | Cl | Cl | H | H | H | H | 3.26 | HERR3288-1-2 | 1619304 |
| 258 | 2-methylpyrrolidin-1-yl | Cl | H | H | H | H | H | 2.87 | HERR3408-1-1 | 1619343 |
| 259 | 2-methylpiperidin-1-yl | Cl | H | H | H | H | H | 3.35 | HERR3409-1-1 | 1619344 |
| 260 | pyrazolidin-1-yl | Cl | Cl | H | H | H | F | 2.29 | HEC9508-1-1 | 1629964 |
| 261 | pyrazolidin-1-yl | Cl | Cl | H | F | H | H | 2.39 | HEC9511-1-1 | 1630088 |
| 262 | pyrazolidin-1-yl | Cl | F | H | F | H | F | 2.32 | HEC9275-1-3 | 1631323 |
| 263 | pyrazolidin-1-yl | Cl | Cl | H | H | H | H | 2.2 | HEC9276-1-1 | 1631327 |
| 264 | 4,5-dimethyltetrahydropyridazin-1(2H)-yl | Cl | F | H | H | H | Cl | 3.32 | HEC9837-1-2 | 1822643 |
| 265 | 4-methyltetrahydropyridazin-1(2H)-yl | Cl | Cl | H | F | H | H | 3.22 | HEC9839-1-2 | 1822652 |
| 266 | 4,5-dimethyltetrahydropyridazin-1(2H)-yl | Cl | Cl | H | F | H | H | 3.43 | HEC9840-1-2 | 1822653 |
| 267 | 4-methyltetrahydropyridazin-1(2H)-yl | Cl | Cl | H | H | H | F | 3.01 | HEC9835-2-4 | 1838868 |
| 268 | 3,5-dimethyl-1H-pyrazol-1-yl | Cl | Cl | H | H | H | F | 2.87 | HEC10104-1-1 | 4205704 |
| 269 | 3,5-dimethyl-IH-pyrazol-1-yl | Cl | Cl | H | F | H | H | 2.94 | HEC10109-1-1 | 4249204 |
| 270 | 4,5-dimethyltetrahydropyridazin-1(2H)-yl | Cl | F | H | F | H | F | 3.35 | HEC10425-1-1 | 4366284 |
| 271 | 4-methyltetrahydropyridazin-1(2H)-yl | Cl | Cl | H | H | H | H | 3 | HEC10424-1-6 | 4394304 |
| 272 | 4-methyl-5,6-dihydropyridazin-1(4H)-yl | Cl | Cl | H | H | H | H | 2.79 | HEC10463-1-1 | 4394311 |
| 273 | 4-methyl-5,6-dihydropyridazin-1(4H)-yl | Cl | F | H | F | H | F | 2.85 | HEC10462-1-1 | 4394314 |
| 274 | 4-methyltetrahydropyridazin-1(2H)-yl | Cl | F | H | F | H | F | 3.05 | HEC10423-1-6 | 4394315 |
| 275 | 4,5-dimethyl-5,6-dihydropyridazin-1(4H)-yl | Cl | Cl | H | H | H | F | 3.15 | HEC10461-1-1 | 4394331 |
| 276 | 4,5-dimethyl-5,6-dihydropyridazin-1(4H)-yl | Cl | F | H | F | H | F | 3.14 | HEC10464-1-1 | 4406998 |
| 277 | 4,5-dimethyl-5,6-dihydropyridazin-1(4H)-yl | Cl | Cl | H | H | H | H | 3.1 | HEC10465-1-1 | 4407008 |
| 278 | 4,5-dimethyltetrahydropyridazin-1(2H)-yl | Cl | Cl | H | H | H | H | 3.3 | HEC10426-1-5 | 4407016 |
| 279 | 4-methylpiperidin-1-yl | Cl | CF₃ | H | H | H | H | 3.8 | HERR5375-1-1 | 5428892 |
| 280 | 4-methylpiperidin-1-yl | CN | Cl | H | H | H | F | 3.37 | GLJ2831-1-3 | 1709754 |

1. A method of controlling a rust disease on a leguminous plant comprising applying one or more compounds of the general formula (I) 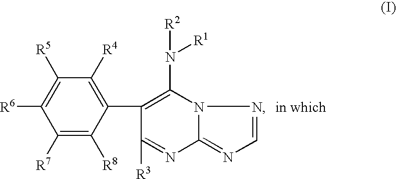
R¹ represents C₁-C6-alkyl, C₁-C₆-haloalkyl or C₂-C₆-alkenyl,
R² represents hydrogen or C₁-C6-alkyl, or
R¹ and R² together with the nitrogen atom to which they are attached form a five-or six-membered heterocycle which may additionally contain up to three heteroatoms selected from the group consisting of nitrogen, oxygen and sulphur and which may be substituted by up to 3 groups selected from the group consisting of trifluoromethyl and methyl, where two oxygen atoms must not be adjacent,
R³ represents C₁-C₄-alkyl, C₁-C₄-alkoxy, C₁-C₄-haloalkyl, cyano, bromine or chlorine, and
R⁴ to R⁸ independently of one another represent hydrogen, fluorine, chlorine, methyl or trifluoromethyl.

2. The method according to claim 1 in which
R¹ represents C₁-C₆-alkyl or C₁-C6-haloalkyl,
R² represents hydrogen or C₁-C₆-alkyl, or
R¹ and R² together with the nitrogen atom to which they are attached form a five- or six-membered heterocycle which may additionally contain up to three heteroatoms selected from the group consisting of nitrogen, oxygen and sulphur and which may be substituted by up to 3 groups selected from the group consisting of trifluoromethyl and methyl, where two oxygen atoms must not be adjacent,
R³ represents methyl, cyano or chlorine, and
R⁴ to R⁸ independently of one another represent hydrogen, fluorine, chlorine, methyl or trifluoromethyl.

3. The method according to claim 1 in which
R¹ represents 3-methylbut-2-yl, 3,3,-dimethylbut-2-yl, 2,2,2-trifluoroethyl or 1,1,1-trifluoroprop-2-yl,
R² represents hydrogen, or
R¹ and R² together represent —(CH₂)—CH(CH₃)—(CH₂)₂—,
R³ represents methyl or chlorine,
R⁴ represents methyl, chlorine or fluorine and R⁵to R⁸ represent hydrogen, or
R⁴ and R⁶ independently of one another represent methyl, chlorine or fluorine and R⁵, R⁷ and R⁸ represents hydrogen, or
R⁴ and R⁸ independently of one another represent methyl, chlorine or fluorine and R⁵, R⁶ and R⁷ represent hydrogen, or
R⁴, R⁶ and R⁸ independently of one another represent methyl, chlorine or fluorine and R⁵ and R⁷ represent hydrogen.

4. The method according to claim 1 in which
R¹ represents 3-methylbut-2-yl, 3,3,-dimethylbut-2-yl, 2,2,2-trifluoroethyl or 1,1,1 -trifluoroprop-2-yl,
R² represents hydrogen, or
R¹ and R² together represent —CH₂)—CH(CH₃)—(CH₂)₂—,
R³ represents chlorine,
R⁴, R⁶ and R⁸ represent fluorine, and
R⁵ and R⁷ represent hydrogen.

5. The method according to claim 1, wherein said compound is 5-chloro-N-[(1R)-1,2-dimethylpropyl]-6-(2,4,6-trifluorophenyl)[1,2,4]triazolo[1,5-a]pyrimidine-7-amine.

6. The method according to claim 1, wherein said compound is 5-chloro-6-(2,4,6-trifluorophenyl)-N-(1R)-(1,2,2-trimethylpropyl)[1,2,4]triazolo[1,5-a]pyrimidine-7-amine.

7. The method according to claim 1, wherein said compound is 5-chloro-7-(4-methylpiperidin-1-yl)-6-(2,4,6-trifluorophenyl)[1,2,4]triazolo[1,5-a]pyrimidine.

8. The method according to claim 1, wherein said compound is 5-chloro-6-(2,4,6-trifluorophenyl)-N-(1S)-( 1,1,1-trifluoropropan-2-yl)-[1,2,4]triazolo[1,5-a]pyrimidine-7-amine.

9. The method according to claim 1, wherein said compound is 5-chloro-6-(2,4,6-trifluorophenyl)-N-(2,2,2-trifluoroethyl)[1,2,4]triazolo[1,5-a]pyrimidine-7-amine.

10. The method according to claim 1, wherein said plant is a soya bean plant.

11. The method according to claim 1 wherein the rust disease is caused by Phakopsora pachyrhizi or Phakopsora meibomiae.

12. The method according to claim 1, wherein a compound of formula (I) is applied to the leguminous plant, its surroundings or its seed.

13. The method according to claim 10 wherein said compound is contacted with the leaves of a soya bean plant.

14. The method according to claim 1 wherein the seed of the leguminous plant is treated with a compound of formula (I).

15. The method according to claim 1 wherein the leguminous plant is a transgenic plant.
